(19) United States
(12) Patent Application Publication
(10) Pub. No.: US 2023/0288592 A1
(43) Pub. Date: Sep. 14, 2023

(54) METHOD FOR PREDICTING A SEISMIC MODEL

(71) Applicant: SAUDI ARABIAN OIL COMPANY, Dhahran (SA)

(72) Inventors: Daniele Colombo, Dhahran (SA); Diego Rovetta, Delft (NL); Weichang Li, Katy, TX (US); Ersan Turkoglu, Dhahran (SA)

(73) Assignee: SAUDI ARABIAN OIL COMPANY, Dhahran (SA)

(21) Appl. No.: 17/654,565

(22) Filed: Mar. 11, 2022

(51) Int. Cl. G01V 1/30; G01V 99/00; E21B 44/00; E21B 49/00

(52) U.S. Cl. CPC G01V 1/306; G01V 1/303; G01V 99/005; E21B 44/00; E21B 49/00; E21B 2200/20; E21B 2200/22; E21B 7/04

(57) ABSTRACT

A system and methods for determining a refined seismic model of a subterranean region are disclosed. The method includes obtaining an observed seismic dataset and a current seismic model for the subterranean region and training a machine learning (ML) network using seismic training models and corresponding seismic training datasets and predicting, using the trained ML network, a predicted seismic model from the observed seismic dataset. The method further includes determining a simulated seismic dataset from the current seismic model and a seismic wavelet, a data penalty function based on a difference between the observed and the simulated seismic datasets and a model penalty function from the difference between the current the predicted seismic models. The method still further includes determining the refined seismic model based on an extremum of a composite penalty function based on a weighted sum of the data penalty function and the model penalty function.

### BACKGROUND

Seismic inversion creates computerized representations of a subterranean region of interest based on seismic observations and their interpretation. Seismic inversion creates seismic models that may represent three-dimensional (3D) images of the subterranean region representing the values of physical quantities, such as the seismic wave propagation velocity, as a function of spatial position within the subterranean region. Furthermore, seismic models may be used in locating and managing the extraction of natural resources like oil and gas.

Generally, seismic inversion methods may be underdetermined, meaning that more than one seismic velocity model may fit the observations with an equivalent degree of fidelity.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for determining a refined seismic model of a subterranean region. The method includes obtaining an observed seismic dataset and a current seismic model for the subterranean region and training a machine learning (ML) network using seismic training models and corresponding seismic training datasets and predicting, using the trained ML network, a predicted seismic model from the observed seismic dataset. The method further includes determining a simulated seismic dataset from the current seismic model and a seismic wavelet, a data penalty function based on a difference between the observed and the simulated seismic datasets and a model penalty function from the difference between the current the predicted seismic models. The method still further includes determining the refined seismic model based on an extremum of a composite penalty function based on a weighted sum of the data penalty function and the model penalty function.

In general, in one aspect, embodiments disclosed herein relate to a non-transitory computer readable medium, storing instructions executable by a computer processor, the instructions including functionality for receiving an observed seismic dataset and a current seismic model of the subterranean region and training a machine learning (ML) network using seismic training models and corresponding seismic training datasets and predicting, using the trained ML network, a predicted seismic model from the observed seismic dataset. The instructions further including functionality for determining a simulated seismic dataset from the current seismic model and a seismic wavelet, a data penalty function based on a difference between the observed and the simulated seismic datasets and a model penalty function from the difference between the current the predicted seismic models. The instructions still further including functionality for determining the refined seismic model based on an extremum of a composite penalty function based on a weighted sum of the data penalty function and the model penalty function.

In general, in one aspect, embodiments disclosed herein relate to a system, including a seismic acquisition system, configured to acquire an observed seismic dataset and a computer system. The computer system is configured to receive an observed seismic dataset and a current seismic model of the subterranean region and train a machine learning (ML) network using seismic training models and corresponding seismic training datasets and predict, using the trained ML network, a predicted seismic model from the observed seismic dataset. The computer system is further configured determine a simulated seismic dataset from the current seismic model and a seismic wavelet, a data penalty function based on a difference between the observed and the simulated seismic datasets and a model penalty function from the difference between the current the predicted seismic models. The computer system is still further configured include to determine the refined seismic model based on an extremum of a composite penalty function based on a weighted sum of the data penalty function and the model penalty function and determine a location of a hydrocarbon reservoir based on the refined seismic model. The system further includes a wellbore planning system configured to plan a planned wellbore path to intersect the location of the hydrocarbon reservoir.

Other aspects and advantages of the claimed subject matter will be apparent from the following description and the appended claims.

### BRIEF DESCRIPTION OF DRAWINGS

FIG. 1 shows a well environment, in accordance with one or more embodiments.

FIG. 2 shows a machine learning network, in accordance with one or more embodiments.

FIG. 3 shows a seismic survey, in accordance with one or more embodiments.

FIG. 4 shows a flowchart for predicting a refined seismic model, in accordance with one or more embodiments

FIG. 5 shows a flowchart of the method steps for predicting seismic properties of a formation, in accordance with one or more embodiments.

FIGS. 6A and 6B show a system in according to one or more embodiments.

FIG. 7 shows a system in according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

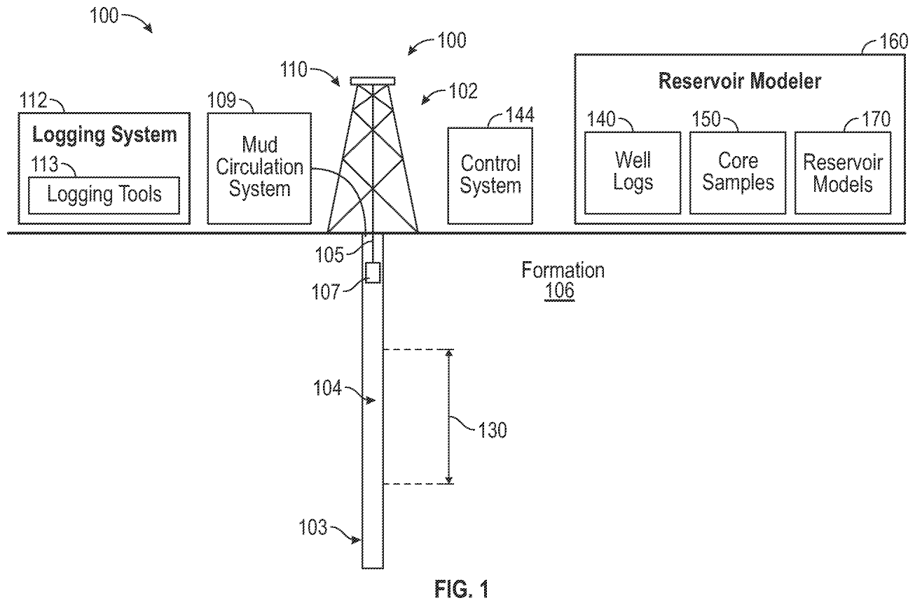

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic training model” includes reference to one or more of such seismic training models.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed provide a workflow for determining a seismic model simultaneously utilizing a physic-based inversion of a seismic dataset and a machine learning (ML)-based prediction from the seismic dataset. Combining a physics-based inversion with a ML-based prediction may decrease the extent to which the problem of determining the seismic model is underdetermined and increase the similarity between the determined seismic model and the true characteristics of the subterranean region.

FIG. 1 illustrates a well environment 100 comprising a well 102 with a wall 103 having a wellbore 104 extending into a formation 106. The wellbore 104 comprises a bored hole that extends from the surface into a target zone of the formation 106, such as a reservoir (not shown). The formation 106 comprises various geophysical formation properties of interest, such as formation porosity, formation permeability, resistivity, water saturation, and free water level (FWL). Porosity indicates how much void space exists in a particular rock within an area of interest in the formation 106, where oil, gas, or water is trapped. Permeability indicates the ability of liquids and gases that flow through the rock within the area of interest. Resistivity indicates how strongly rock or fluid within the formation 106 opposes the flow of electrical current. For example, resistivity indicates the porosity of the formation 106 and the presence of hydrocarbons. More specifically, resistivity is relatively low for a formation that has high porosity and a large amount of water, and resistivity is relatively high for a formation that has low porosity or comprises a large quantity of hydrocarbons. Water saturation indicates the fraction of water in a given pore space.

Keeping with FIG. 1, the well environment 100 comprises a drilling system 110, a logging system 112, a control system 144, and a reservoir modeler 160. The drilling system 110 comprises a drill string (105), drill bit (107), and a mud circulation system (109) for use in boring the wellbore 104 into the formation 106. The control system 144 comprises hardware or software for managing drilling operations or maintenance operations. For example, the control system 144 may include one or more programmable logic controllers (PLCs) comprising hardware or software with functionality to control one or more processes performed by the drilling system 110. Specifically, a programmable logic controller may control valve states, fluid levels, pipe pressures, warning alarms, or pressure releases throughout a drilling rig. In accordance with some embodiments, the programmable logic controller may be a ruggedized computer system with functionality to withstand vibrations, extreme temperatures (for example, ˜575° C.), wet conditions, or dusty conditions, for example, around a drilling rig. The term “control system” refers broadly to systems that effect control including, for example and without limitation, a drilling operation control system that is used to operate and control the equipment, a drilling data acquisition and monitoring system that is used to acquire drilling process and equipment data and to monitor the operation of the drilling process, and/or a drilling interpretation software system that is used to analyze and understand drilling events and progress.

The logging system 112 includes one or more logging tools 113. The logging tools 113 may be any type of logging tool known in the art, such as a nuclear magnetic resonance (NMR) logging tool or a resistivity logging tool, for use in generating well logs 140 of the formation 106. For example, a logging tool may be lowered into the wellbore 104 to acquire measurements as the tool traverses a depth interval 130 (for example, targeted reservoir section) of the wellbore 104. Alternatively, the logging tool may be incorporated into the drill string. The plot of the logging measurements versus depth refers to a “log” or “well log”. Well logs 140 provide depth measurements of the wellbore 104 that describe such reservoir characteristics as formation porosity, formation permeability, resistivity, water saturation, and the like. The resulting logging measurements are stored or processed or both, for example, by the control system 144, to generate corresponding well logs 140 for the well 102. A well log comprises a plot of a logging response time versus true vertical depth (TVD) across the depth interval 130 of the wellbore 104.

Reservoir characteristics are determined using a variety of different techniques. For example, certain reservoir characteristics may be determined via coring (for example, physical extraction of rock samples) to produce core samples 150. Alternatively, or additionally, reservoir characteristics may be determined by logging operations (for example, wireline logging, logging-while-drilling (LWD) and measurement-while-drilling (MWD)). Coring operations comprise physically extracting a rock sample from a region of interest within the wellbore 104 for detailed laboratory analysis. For example, when drilling an oil or gas well, a coring bit cuts plugs (or “cores”) from the formation 106 and bring the plugs to the surface. These core samples are then analyzed at the surface (for example, in a lab) to determine various characteristics of the formation 106 at the location where the sample was obtained. One example of a reservoir characteristic is the amount of oil present in the reservoir. Another is the permeability of the reservoir rock. Reservoir monitoring is an operation involving the mapping of fluid movements within the reservoir as a consequence of oil production.

Multiple types of logging techniques are available for determining various reservoir characteristics. For a particular application, one or more form of logging may be selected and used based on the logging conditions and the type of desired measurements. For example, NMR logging measures the induced magnetic moment of hydrogen nuclei (that is, protons) contained within the fluid-filled pore space of porous media (for example, reservoir rocks). Thus, NMR logs measure the magnetic response of fluids present in the pore spaces of the reservoir rocks. In doing so, NMR logs measure both porosity and permeability as well as the types of fluids present in the pore spaces. For determining permeability, another type of logging is used that is called spontaneous potential (SP) logging. SP logging determines the permeabilities of rocks in the formation 106 by measuring the amount of electrical current generated between a drilling fluid produced by the drilling system 110 and formation water that is present in pore spaces of the reservoir rock. Porous sandstones with high permeabilities generate more electricity than impermeable shales. Thus, SP logs are used to identify sandstones from shales.

To determine porosity in the formation 106, various types of logging techniques are used. For example, the logging system 112 may measure the speed at which acoustic waves travel through rocks in the formation 106. This type of logging generates borehole compensated (BHC) logs, which are also called sonic logs and acoustic logs. Sound waves travel faster through shales than through sandstones because shales have greater density than sandstones. Likewise, density logging also determines porosity by directly measuring the density of the rocks in the formation 106. In addition, neutron logging determines porosity by assuming that the reservoir pore spaces within the formation 106 are filled with either water or oil and then measuring the amount of hydrogen atoms (that is, neutrons) in the pores. Furthermore, the logging system 112 may determine geological data for the well 102 by measuring corresponding well logs 140 and data regarding core samples 150 for the well 102.

Keeping with the various types of logging techniques, resistivity logging measures the electrical resistivity of rock or sediment in and around the wellbore 104. In particular, resistivity measurements may determine what types of fluids are present in the formation 106 by measuring how effective these rocks are at conducting electricity. Fresh water and oil are both poor conductors of electricity, thus they have high relative resistivities. For example, an electrical resistivity of crude oil ranges from 4.0×106 to 1.5×108 ohm-meter and the electrical resistivity of fresh water is in the range of 10-100 ohm-meter. However, in hydrocarbon reservoirs, pores are seldom filled with pure water or pure crude oil and the resistivity contrasts are much smaller. For example, in mainly water-filled formations the resistivity values may lie in the range 0.2-10 ohm-meter, while in mainly oil-filled formations the resistivity values may lie in the range 20-2000 ohm-meters. As such, resistivity measurements obtained via such logging may be used to determine corresponding reservoir water saturation (Sw).

Turning to the reservoir modeler 160, the reservoir modeler 160 comprises hardware or software with functionality for generating one or more reservoir models 170 regarding the formation 106. For example, the reservoir simulator 160 may store (or receive) well logs 140 and data regarding core samples 150, and further analyze the well log data, the core sample data, seismic data, or other types of data to generate or update the one or more reservoir models 170. The reservoir modeler 160 may couple to the logging system 112 and the drilling system 110.

In some embodiments, the reservoir modeler 160 comprises functionality for applying deep learning or artificial intelligence methodologies to precisely determine various subsurface layers. To do so, a large amount of interpreted data may be used to train a geophysical model. To obtain this amount of data, the reservoir modeler 160 augments acquired data for various geological scenarios and drilling situations. For example, drilling logs provide similar log signatures for a particular subsurface layer except where a well encounters abnormal cases. Such abnormal cases comprise changes in subsurface geological compositions, well placement of artificial materials, or various subsurface mechanical factors that affect logging tools. As such, the amount of well data with abnormal cases available to the reservoir modeler 160 may be insufficient for training a geophysical model. Therefore, in some embodiments, a reservoir simulator 160 uses data augmentation to generate a dataset that combines original acquired data with augmented data based on geological and drilling factors. The supplemented dataset provides sufficient geophysical training data to train a geophysical model accordingly.

In some embodiments, the reservoir modeler 160 is implemented in a software platform for the control system 144. The software platform obtains data acquired by the drilling system 110 and logging system 112 as inputs, which comprise multiple data types from multiple sources. The software platform aggregates the data from these systems 110, 112 in real time for rapid analysis. Real-time of or relating to computer systems in the software platform is defined as the actual time for updating information with instantaneous processing at the same rate as required by a user or necessitated by a process being controlled.

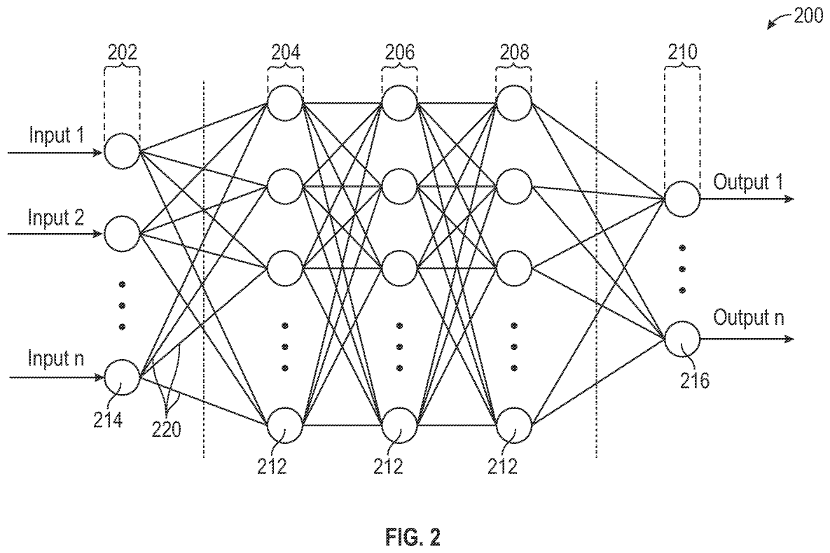

FIG. 2 illustrates an artificial neural network (200) (hereinafter also “neural network”) in accordance with one or more embodiments. A neural network (200) uses a series of mathematical functions to make predictions based on observations. A neural network (200) may include an input layer (202), hidden layers such as a first hidden layer (204), a second hidden layer (206), a third hidden layer (208) and an output layer (210). Each layer represents a vector where each element within each vector is represented by an artificial neuron, such as artificial neuron (212) (hereinafter also “neuron”). An artificial neuron is loosely based on a biological neuron of the human brain. The input layer (202) may receive an observed data vector x where each neuron, such as neuron (214), within the input layer (202) receives one element xᵢ within x. Each element is a value that represents a datum that is observed. The vector x may be called “input data” and, in some embodiments, may be geophysical data. FIG. 2 displays the input data or vector x as elements x₁, x₂, . . . xₙ, where x₁ may be a value that represents a measured value of gravity at a first spatial position, x₂ may be a value that represents a measured value of gravity at a second spatial position, etc.

The output layer (210) may represent the vector y where each neuron, such as neuron (216) within the output layer (210) represents each element yᵢ within y. The vector y may be called “output data” and, in some embodiments, may be a predicted geophysical model. FIG. 2 displays the output data or vector y as two elements y₁ and y₂ where y₁ may be a value that represents density at a first spatial location within a subterranean region and y₂ represents density at a second spatial location within a subterranean region.

Neurons in the input layer (202) may be connected to neurons in the first hidden layer (204) through connections, such as connections (220). A connection (220) may be analogous to a synapse of the human brain and may have a weight associated to it. The weights for all connections (220) between the input layer (202) and the first hidden layer (204) make up a first array of weights wᵢⱼ where:

$${w}_{i j} = [ \begin{matrix}{w}_{11} & {w}_{12} & {w}_{13} \\ {w}_{21} & {w}_{22} & {w}_{23} \\ {w}_{31} & {w}_{32} & {w}_{33}\end{matrix} ] , \qquad Equation ( 1 )$$

for the embodiment shown in FIG. 2. The elements in each column are the weights associated with the connections (220) between each of the three elements in vector xᵢ that propagate to the same neuron (212) in the first hidden layer (204). The vector xᵢ and the first array of weights wᵢⱼ may be multiplied together, the bias terms bⱼ added, if applicable, and scaled by the activation functions gⱼ to determine the vector aⱼ where each element may be a value represented by a neuron (212) in the first hidden layer (204) such that:

aⱼ=gᵢ(bⱼ+Σᵢxᵢwᵢⱼ). Equation (2)

Each weight within the first array of weights wᵢⱼ may amplify or reduce the significance of each element within vector xᵢ. The bias terms bⱼ shift the vector xᵢ and the activation functions gⱼ determine the amplitude of the weighted summation. The activation functions gⱼ may be, without limitation, an identity function, a logistic function, a sigmoid function, a hyperbolic tangent function, a Gaussian error linear unit (GELU) function, a softplus function, a Gaussian function, a shifted quadratic unit (SQU) function, and a decaying sine unit function. The activation functions selected may depend, at least in part, on if the neural network (200) is being used to solve a regression problem or a classification problem.

Similarly, the weights for all connections (220) between the first hidden layer (204) and the second hidden layer (206) make up a second array of weights wⱼₖ. The vector aⱼ and the second array of weights wⱼₖ may be multiplied together, the bias terms bₖ added, if applicable, and scaled by the activation functions gₖ to determine the vector aₖ where each element is a value represented with a neuron (212) in the second hidden layer (204) such that:

aₖ=gₖ(bₖ+Σⱼaⱼwⱼₖ). Equation (3)

Continuing with the embodiment of FIG. 2, the weights for all connections (212) between the second hidden layer (206) and the output layer (210) make up a third array of weights wₖₗ. The vector aₖ and the third array of weights wₖₗ may be multiplied together, the bias terms bₗ added, if applicable, and scaled by the activation functions gₗ to determine the vector yₗ. A person of ordinary skill in the art will appreciate that FIG. 2 depicts one highly simplified version of the action of a neural network (200). The weights between the second hidden layer (206) and subsequent layers, such as hidden layer (208) are handled in a similar manner.

For a neural network (200) to complete a “task” of predicting output data from observed input data, the neural network (200) must first be trained. Training may be defined as the process of determining the values of the weights within each array of weights and the values of each bias term such that the neural network (200) makes accurate predictions. Training may be performed iteratively, where each iteration is referred to as an “epoch”, using training data and backpropagation. The training data may be a plurality of input data and a plurality of output data both of which are observed. Assume a plurality of vectors xₘⁿ and a plurality of vectors y′ₚⁿ collectively make up the training data. Backpropagation is defined as using a gradient descent algorithm to update the weights and bias terms within a neural network (200). Gradient descent algorithms may include, without limitation, stochastic gradient descent, batch gradient descent, Momentum gradient descent, Adadelta gradient descent, Adam gradient descent, and Nadam gradient descent.

Prior to training a neural network, the weights within all arrays of weights and the bias terms may be initialized as small, random values. During training, the input data within a batch of training data, such as xₘ¹ through xₘ⁵, may be input into the neural network (200) to predict yₚ¹ through yₚ⁵. The predicted vectors yₚ¹ through yₚ⁵, are then compared to the output data within the batch of training data y′ₚ¹ through y′ₚ⁵ using a residual function R. The residual function R may also be referred to as a penalty function, an objective function, a cost function, a loss function, or an error function. In some embodiments, the residual function R may be the sum of the squared errors such that:

$$R = \frac{1}{2} {\sum }_{n = 1}^{5} {( {y}_{p}^{n} - {y}_{p}^{n} )}^{2} . \qquad Equation ( 4 )$$

The gradient of the residual function R with respect to each of the weights may then be determined and used by a gradient descent algorithm to adjust each weight and each bias term in the proper direction. Additional epochs using a plurality of batches within the training data may be performed. In some embodiments, a neural network may be considered adequately trained once the residual function R for all training data reaches a threshold or once a pre-defined number of epochs have been performed.

Following training, the neural network (200) may perform a task where the vector xₘ¹, a part of the training data, is input into the neural network (200) to predict the vector yₚ¹ where the residual between yₚ¹ and y′ₚ¹ should be negligible.

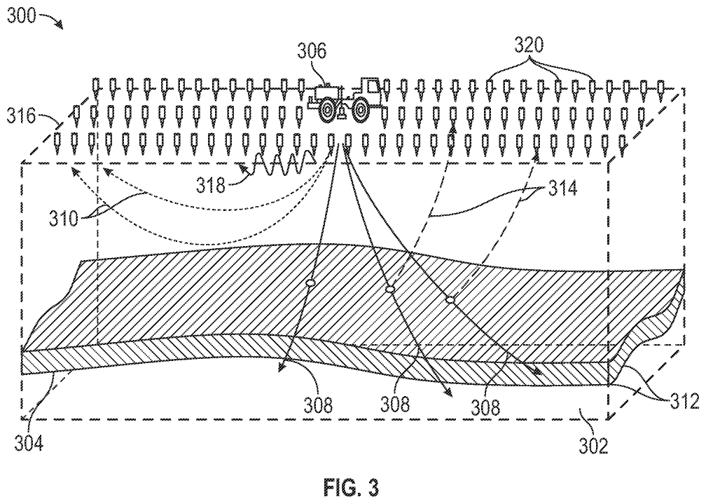

FIG. 3 shows a seismic survey (300) of a subterranean region of interest (302), which may contain a hydrocarbon reservoir (304). In some cases, the subterranean region of interest (302) may lie beneath a lake, sea, or ocean. In other cases, the subterranean region of interest (302) may lie beneath an area of dry land. The seismic survey (300) may utilize a seismic source (306) that generates radiated seismic waves (308). The type of seismic source (306) may depend on the environment in which it is used, for example on land the seismic source (306) may be a vibroseis truck or an explosive charge, but in water the seismic source (306) may be an airgun. The radiated seismic waves (308) may return to the Earth's surface (316) as refracted seismic waves (310) or may be reflected by geological discontinuities (312) and return to the surface as reflected seismic waves (314). The radiated seismic waves may propagate along the surface as Rayleigh waves or Love waves, collectively known as “ground-roll” (318). Vibrations associated with ground-roll (318) do not penetrate far beneath the Earth's surface (316) and hence are not influenced, nor contain information about, portions of the subterranean region of interest (302) where hydrocarbon reservoirs (304) are typically located. Seismic receivers (320), located on or near the Earth's surface (316), detect reflected seismic waves (314), refracted seismic waves (310) and ground-roll (318).

In accordance with one or more embodiments, the refracted seismic waves (310), reflected seismic waves (314), and ground-roll (318) generated by a single activation of the seismic source (306) are recorded by a seismic receiver (320) as a time-series representing the amplitude of ground-motion at a sequence of discreet sample times. Usually the origin of the time-series, denoted t=0, is determined by the activation time of the seismic source (306). This time-series may be denoted a seismic “trace”. The seismic receivers (320) are positioned at a plurality of seismic receiver locations which we may denote (xᵣ, yᵣ) where x and y represent orthogonal axes on the Earth's surface (316) above the subterranean region of interest (302). Thus, the plurality of seismic traces generated by activations of the seismic source (306) at a single location may be represented as a three-dimensional “3D” volume with axes (xᵣ, yᵣ, t) where (xᵣ, yᵣ) represents the location of the seismic receiver (316) and t denotes the time sample at which the amplitude of ground-motion was measured.

However, a seismic survey (300) may include recordings of seismic waves generated by a seismic source (306) sequentially activated at a plurality of seismic source locations denoted (xₛ,yₛ). In some cases, this may be achieved using a single seismic source (306) that is moved to a new location between activations. In other cases, a plurality of seismic sources (306) positioned at different locations may be used. Irrespective of how they are acquired, all the seismic traces acquired by a seismic survey (300) may be represented as a five-dimensional volume, with coordinate axes (xₛ, yₛ, xᵣ, yᵣ, t), and called a “seismic dataset”.

When a seismic dataset is acquired by activating physical seismic sources and recording the actual resulting vibrations of the Earth using physical seismic receivers, the seismic dataset may be termed an “observed seismic dataset” and the component seismic traces “observed seismic traces”. However, a seismic dataset may be simulated by solving the acoustic, elastic, or viscoelastic wave equations for at least one simulated seismic source and a plurality of seismic receiver locations. Typically, the solving is performed using a large capacity computer system. The resulting seismic dataset may be termed a “simulated seismic dataset” and the component seismic traces “simulated seismic traces”.

A seismic dataset must be processed to produce valuable information, such as one or more seismic images or one or more seismic attributes. Typically, a seismic processing workflow addresses a sequence of steps. These steps may be divided into pre-processing that typically include acquisition regularization, noise attenuation, multiple identification and multiple attenuation. A preprocessed seismic dataset may be produced from an observed seismic dataset by preprocessing.

The preprocessed seismic dataset may further be processed. These further processing steps may include seismic wave propagation velocity determination, seismic imaging, and seismic attribute determination. Several of these steps, such as seismic imaging and seismic attribute attenuation, may require further interpretation to identify the locations within the subsurface at which hydrocarbon accumulations may be present. In some embodiments, the interpretation may occur after the generation of the post-stack seismic image or the seismic attribute. In other embodiments, the interpretation may be performed in parallel or interleaved or integrated into the process of determining the post-stack seismic image or the seismic attribute.

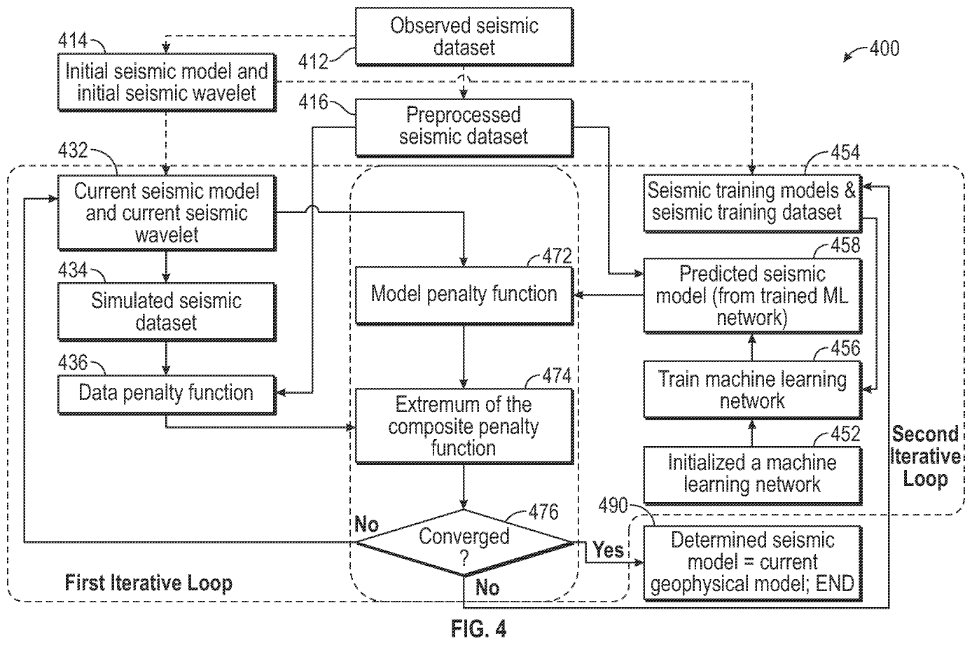

In accordance with one or more embodiments, FIG. 4 shows a flowchart (400) for predicting a seismic model of a subterranean region. Flowchart (400) depicts an iterative or recursive process. Furthermore, flowchart (400) shows two coupled iterative loops. A first iterative loop is formed by the blocks (432), (434), (436), (472) and (474), and (476). A second iterative loop is formed by blocks (454), (456), (458), (472), (474) and (476). The two iterative loops share blocks (472), (474) and (476).

In accordance with one or more embodiments, in Block (412) an observed seismic dataset may be acquired using sensors deployed on the surface of the earth, within a body of water, or downhole.

In Block (414) an initial seismic model may be obtained. In accordance with some embodiments the initial seismic model may be obtained from the observed seismic dataset (412). For example, the initial seismic model (414) may be obtained from the observed seismic dataset (412) using crude or approximate methods. In other embodiments, the initial seismic model (414) may be obtained using plausible assumptions about the structure of the subterranean region, such as the assumption that density or seismic velocity increases linearly with depth and be invariant with respect to horizontal location, without departing from the scope of the invention.

The initial seismic model (414) may be regarded as depicting a crude approximation to the structure of the subsurface. The initial seismic model may take the form of a three-dimensional (3D) grid with a value of a physical parameter specified at each node. In some embodiments, the 3D grid may be a Cartesian grid and in other embodiments the 3D grid may be an irregular grid.

Further, in Block (414) in accordance with one or more embodiments, an initial seismic wavelet may be determined. The initial seismic wavelet may be an initial estimate of the time-dependent excitation function applied by the seismic source (306) to the earth. In some embodiments, the initial seismic wavelet may be determined from a mathematical model describing the functioning of the seismic source (306). In other embodiments, the initial seismic wavelet may be determined from vibration sensors located on or near the seismic source (306). In still other embodiments, the initial seismic wavelet may be determined from the observed seismic dataset (412).

In Block (432) a current seismic model may be determined. Initially, the current seismic model may be defined to be equal to the initial seismic model. Further, in Block (432) a current seismic wavelet may be determined. Initially, the current seismic wavelet may be defined to be equal to the initial seismic wavelet. Both the current seismic model and the current seismic wavelet may be updated with each iteration of the iterative loop of the inversion.

In Block (434) a simulated seismic dataset may be generated from the current seismic model using the current seismic wavelet. The simulated seismic dataset may be generated by solving mathematical equations that describe the physical laws governing the relationship between the observed seismic dataset and the current seismic model. For example, Newton's second law (the equation of motion) and the constitutive relation for elastic materials govern the prediction of seismic measurements from the elastic properties and density of the subterranean region. These mathematical equations may be solved using numerical methods such as, without limitation, finite-difference, finite-element or discrete Galerkin algorithms.

In Block (416) a preprocessed seismic dataset may be determined from the observed seismic dataset (412). The preprocessing may include without limitation, acquisition geometry regularization, noise reduction techniques, filtering, estimation and correction of near-surface effects (“statics”) and smoothing the observed seismic dataset (412).

In Block (436) a data penalty function may be formed that measures the difference between the simulated seismic dataset (434) and the preprocessed seismic dataset (416). In some embodiments the data penalty function, ϕ_{d}(m), may be a least squares penalty function:

ϕ_{d}(m)=(Gm−d_{obs})^{T}W_{d}^{T}W_{d}(Gm−d_{obs}), Equation (5)

where Gm represents the simulated seismic dataset obtained by applying a physics-based deterministic Jacobian operator, G, to the current seismic model, m, d_{obs} is the observed seismic dataset, and W_{d} represents a data weighting matrix (and W_{d}^{T}W_{d} is the equivalent inverse covariance). In other embodiments, other data penalty functions may be used without departing from the scope of the invention. In Block (452) a machine learning network may be initialized. The machine learning network maybe an artificial neural network (ANN). In particular, the ANN may be a deep learning (DL) network. An example of a DL network is depicted in FIG. 2 and described in the context thereof. In brief, initializing the ML network may include providing an initial value for a plurality of network parameters θ₀. The network parameters may include a set of weights and biases for the plurality of nodes within the ML network.

In Block (454) a set of seismic training models and a set of corresponding seismic training datasets may be provided. In accordance with one or more embodiments, the set of seismic training models may be based, at least in part, on the initial seismic model (414). For example, in some embodiments, the seismic training models may have parameter values that are similar to those of the initial seismic model (414). Alternatively, the seismic training models may be constructed by adding a random perturbation to the parameter values for the initial seismic model (414).

In accordance with one or more embodiments, for each seismic training model a corresponding seismic training dataset may be simulated. The simulation may be performed by solving mathematical equations that describe the physical laws governing the relationship between the seismic training dataset and the seismic training model. For example, Newton's second law (the equation of motion) and the constitutive relation for elastic materials govern the prediction of seismic measurements from the elastic properties of the subterranean region. These mathematical equations may be solved using numerical methods such as, without limitation, finite-difference, finite-element or discrete Galerkin algorithms.

In Block 456, in accordance with one or more embodiments, the ML network may be trained to predict a predicted seismic model based on a seismic dataset. During the training phase each seismic dataset may be drawn from the seismic training datasets (454). The training may be performed by inputting the seismic training dataset, dₜ, into the input layer (210) of the ML network (200) and allowing the ML network (200) to predict a predicted seismic model output from the output layer (250) of the ML network (200). The predicted seismic model generated by the ML network (200) from the seismic training dataset may be denoted \tilde{m}ₜ. \tilde{m}ₜ is an estimate of the corresponding seismic training model, mₜ.

The predicted seismic model, mₗ, may be written as a pseudo-inverse ML Jacobian operator, H_{θ}^{†}, that is a function of the ML network parameters θ₀, is applied to the seismic training dataset, dₜ, i.e., \tilde{m}ₜ=H_{θ}^{†}dₜ.

In accordance with some embodiments, a training penalty function, ϕ_{l,m}, may be formed. The training may be performed as an iterative loop, enumerated by an index, k. In accordance with some embodiments, the training penalty function may be written:

$${ϕ}_{l , m} = {‖ {\tilde{m}}_{t}^{k} - {m}_{t} ‖}_{{L}_{2}}^{2} + {μ}_{3} {ϕ}_{d , H} ( {m}_{t}^{k} , θ ) \qquad Equation ( 6 )$$

where the first term in equation (6) is a model penalty function that measures the difference between the training model, mₜ and the predicted training model, \tilde{m}ₜ^{k}, at the k-th iterative loop. The second term in equation (6) is a data penalty function that measures the difference between the training data and the ML-network predicted data, H_{θ}mₜ^{k}, generated using the ML Jacobian operator H_{θ} at the k-th iterative loop:

$${ϕ}_{d , H} ( {\tilde{m}}_{t}^{k} , θ ) = {( {H}_{θ} {\tilde{m}}_{t}^{k} - {d}_{t} )}^{T} {W}_{d , H}^{T} {W}_{d , H} ( {H}_{θ} {\tilde{m}}_{t}^{k} - {d}_{t} ) \qquad Equation ( 7 )$$

where W_{d,H} is a data weighting matrix (and W_{d,H}^{T}W_{d,H} the equivalent inverse covariance) and μ₃ a weight controlling the relative importance between the first and second terms in equation (6).

At each iteration, k, of the training iterative loop, the ML network parameters θ^{k} may be determined by minimizing the training penalty function given in equation (6):

$${θ}^{k} = arg {min}_{θ} [ {ϕ}_{l} ( {\tilde{m}}_{t}^{k} , {θ}^{k - 1} ) + {μ}_{3} {ϕ}_{d , H} ( {\tilde{m}}_{t}^{k} , {θ}^{k - 1} ) ] \qquad Equation ( 8 )$$

At the next (k+1-th) and subsequent iterations, equations (6), (7) and (8) may be re-evaluated until the iterative loop converges and the ML network is “trained”. Convergence may be indicated by the value of

$${min}_{θ} [ {ϕ}_{l} ( {\tilde{m}}_{t}^{k} , {θ}^{k - 1} ) + {μ}_{3} {ϕ}_{d , H} ( {\tilde{m}}_{t}^{k} , {θ}^{k - 1} ) ]$$

falling below a predetermined value, or the decrease in the value between consecutive iterations falling below a predetermined value, or a predetermined number of iterations being completed.

In accordance with other embodiments, a training penalty function, ϕ_{l,m}, may be formed. The training may be performed as an iterative loop, enumerated by an index, k. In accordance with some embodiments, the training penalty function may be written:

$${ϕ}_{l , m} = {‖ {\tilde{m}}_{t}^{k} - {m}_{t} ‖}_{{L}_{2}}^{2} + {μ}_{4} {ϕ}_{d , G} ( {\tilde{m}}_{t}^{k} , θ ) . \qquad Equation ( 9 )$$

where μ₄ is a weight controlling the relative importance between the first and second terms in equation (9). The first term in equation (9) is a model penalty function that measures the difference between the training model, mₜ and the predicted training model, \tilde{m}ₜ^{k}, at the k-th iterative loop. The first term in equation (9) may be the same as the first term in equation (6). However, the second term in equation (9) is a data penalty function that measures the difference between the training data and physics-based or deterministic data, Gmₗ^{k}, generated using the physics-based or deterministic Jacobian operator G at the k-th iterative loop:

$${ϕ}_{d , G} ( {\tilde{m}}_{t}^{k} , θ ) = {( G {\tilde{m}}_{t}^{k} - {d}_{t} )}^{T} {W}_{d , G}^{T} {W}_{d , G} ( G {\tilde{m}}_{t}^{k} - {d}_{t} ) \qquad Equation ( 10 )$$

where W_{d,G} is a data weighting matrix (and W_{d,G}W_{d,G} the equivalent inverse covariance). The minimum of equation (10) may be found in exactly the same iterative fashion described previously for equation (8). In accordance with one or more embodiments, a deterministic Jacobian determined from the current seismic model may be passed from Block (476) to Block (454), together with the current seismic model and the corresponding simulated seismic dataset to augment the set of seismic training models and seismic training datasets.

In Block (458), the trained ML network (456) may be applied to the preprocessed seismic dataset (416), dₚₚ, to predict the predicted seismic model, mₚ, corresponding to the preprocessed seismic dataset (416), i.e., mₚ=H_{θ}^{†}dₚₚ. The predicted seismic model, mₚ, is a ML network prediction of the seismic model for the subterranean region based on the preprocessed seismic dataset (416).

In Block (472) a model penalty function may be determined, in accordance with one or more embodiments. The model penalty function may be designed to promote a progressive similarity between current seismic model and the predicted seismic model over the course of the workflow. In accordance with some embodiments, the model penalty function formed in (472) may include more than one term, for example it may contain three terms. The first term of the model penalty function formed in (472) may be a measure of the difference between the current seismic model determined in Block (432) and the predicted seismic model predicted in Block (458) by the trained ML network. The second term of the model penalty function formed in (472) may be a measure of the differences in a spatial variation of current seismic model and the predicted seismic model. The third term of the model penalty function (472) may be a measure of the correlation between the values of current seismic model and the predicted seismic model.

For example, in accordance with one or more embodiments, the first term, ϕₘ(m, mₚ(θ)), may measure the difference between the current seismic model, m, and the predicted seismic model (458), denoted mₚ. In accordance with some embodiment, ϕₘ(m, mₚ(θ)) may be written as:

ϕₘ(m,mₚ(θ))=(m−mₚ(θ))^{T}W_{m,p}^{T}W_{m,p}(m−mₚ(θ)), Equation (11)

where mₚ is the predicted seismic model obtained during the training phase and W_{m,p} is a seismic model covariance matrix.

In Block (474), in accordance with one or more embodiments, a composite penalty function may be formed by combining the data penalty function and the model penalty function. For example, the composite penalty function may be a weighted sum of the data penalty function and the model penalty function. Furthermore, in Block (474) an extremum of the composite penalty function may be found by updating the current seismic model (432) to produce the extremum of the composite penalty function. In some embodiments, the extremum may be a minimum, while in other embodiments, the extremum may be a maximum.

In Block (476), in accordance with one or more embodiments a convergence test may be applied to the composite penalty function. Some possible forms of the convergence test are described below. If the convergence test is passed, the workflow terminates by assigning the current seismic model to be the updated seismic model in Block (490). However, if the convergence test is failed the workflow iterates. For example, the updated seismic model becomes the current seismic model, and the loop containing Blocks (434), (436), (474) and (476) iterates. Further, the seismic training models and corresponding seismic training data may be augmented by the updated seismic model and the corresponding simulated seismic dataset. Further, in accordance with one or more embodiments, in Block (456), the trained ML network may be retrained using the augmented set of seismic training models and corresponding seismic training data.

In accordance with one or more embodiments, the retrained ML learning network determined in Block (456) may be used to predict a new predicted seismic model in Block (458) and the loop containing blocks (456), (458), (472), and (474) iterates.

In Block (476), in accordance with one or more embodiments, a convergence test may be applied. For example, in some embodiments the convergence condition may be that the extremum value is a minimum value of the composite penalty function and may be smaller than a predetermined value. In other embodiments, the convergence condition may be that the value of the composite penalty function has decreased by less than a predetermined value from the previous evaluation of the composite penalty function. In still other embodiments, the extremum value is a maximum value of the composite penalty function and may be greater than a predetermined value. The convergence test may, in other embodiments, be that a predetermined number of iterations have been completed, irrespective of the final value of the composite penalty function.

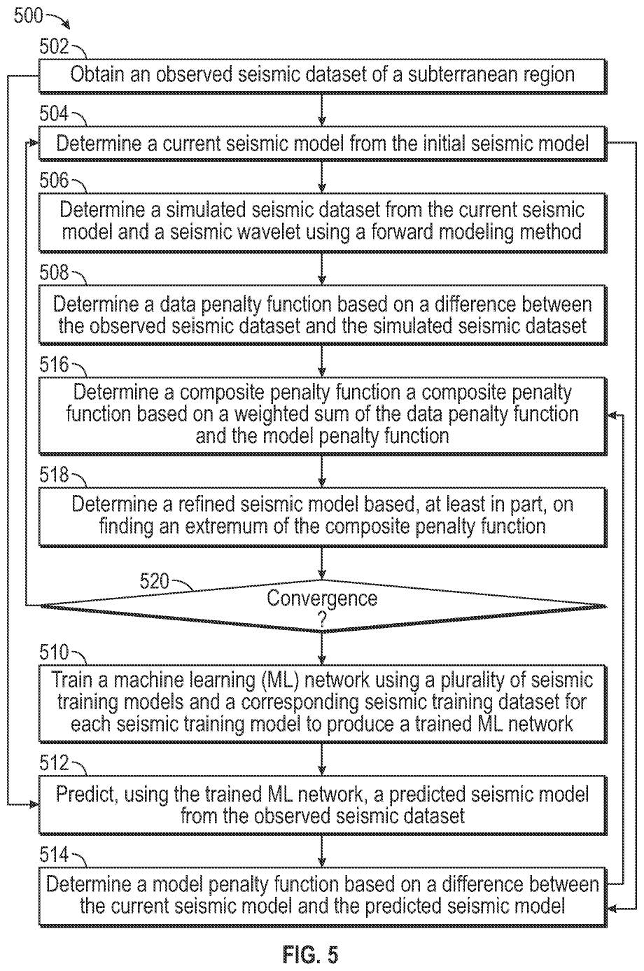

FIG. 5 shows a flowchart (500), in accordance with one or more embodiments, for predicting a seismic model of a subterranean region of interest.

In Step 502, an observed seismic dataset may be obtained for a subterranean region of interest using a seismic survey (300). The seismic survey may be obtained using seismic source and seismic receivers deployed on the surface of the Earth, within a body of water, such as the ocean, or downhole.

In Step 504, a current seismic model may be obtained for the subterranean region of interest. The current seismic model describes a plurality of seismic parameter of the subterranean region. In accordance with some embodiments, the initial seismic model may take the form of a three-dimensional (3D) grid with a value of a seismic parameter, such as seismic wave propagation velocity, specified at each node In some embodiments, the 3D grid may be a Cartesian grid and in other embodiments the 3D grid may be an irregular grid. The initial seismic model may be determined, using approximate methods, from the observed seismic dataset, from well log recorded in wellbores penetrating the subterranean region, or from simplistic assumptions, such as the assumption that density increases linearly with depth, without departing from the scope of the invention.

In Step (506) a simulated seismic dataset may be determined from the current seismic model and a seismic wavelet using a forward modeling method. The forward modeling method may be a physics-based forward modeling method, such as a numerical solution of the elastic or acoustic wave equation. In some embodiments, the numerical solution may be a finite-difference method, a finite-element method, or a discrete Galerkin method. The numerical solution may operate in the time-domain or the frequency domain.

In Step (508) a data penalty function based on a difference between the observed seismic dataset and the simulated seismic dataset may be determined. In some embodiments, the data penalty function may be a least-squares function.

In Step 510, in accordance with one or more embodiments, a machine learning network may be trained, using a plurality of seismic training models and a corresponding seismic training dataset for each seismic training model, to produce a trained ML network.

In accordance with some embodiments, training the ML network may include forming a model penalty function that measures the difference between each seismic training model and a predicted seismic training model determined from the seismic dataset corresponding to each seismic training model. Furthermore, training the ML network may include a data penalty function based on a ML Jacobian operator of the predicted seismic dataset with respect to a plurality of parameters of the seismic training model; and, determining a composite training penalty function from weighted sum of the model penalty function and the data penalty function. Finally, training the ML network may be based, at least in part, on finding an extremum of the composite training penalty function.

In accordance with other embodiments, training the ML network may include forming a model penalty function that measures the difference between each seismic training model and a predicted seismic training model determined from the seismic dataset corresponding to each seismic training model. Furthermore, training the ML network may include a data penalty function based on a physics based deterministic Jacobian operator of the predicted seismic dataset with respect to a plurality of parameters of the seismic training model; and, determining a composite training penalty function from weighted sum of the model penalty function and the data penalty function. Finally, training the ML network may be based, at least in part, on finding an extremum of the composite training penalty function.

In Step 512, in accordance with some embodiments, a predicted seismic model may be determined from the observed seismic dataset. In accordance with other embodiments, the predicted seismic model may be determined from the preprocessed seismic dataset.

In Step 514, in accordance with one or more embodiments, a model penalty function may be determined based on a difference between the current seismic model and the predicted seismic model. In accordance with some embodiments, the model penalty function may be a least-squares penalty function. In accordance with other embodiments, the model penalty function may include contributions penalizing structural dissimilarity between the current seismic model and the predicted seismic model. For example, structural dissimilarity may include differences in a spatial gradient of a model parameter between the two model, or differences in the location of discontinuities of a model parameter between the two models.

In Step 516 a composite penalty function may be formed. The composite penalty function may include the data penalty function and the model penalty function. For example, the composite penalty function may be a weighted sum of the data penalty function and the model penalty function.

Further in Step 518 a refined seismic model may be determined based, at least in part, on determining an extremum of the composite penalty function. The extremum of the composite penalty function may be found by adjusting the parameters of the current seismic model. In some embodiments, the extremum may be a minimum while in other embodiments the extremum may be a maximum. The adjusted seismic model parameters that produce an extremum of the composite objective function may be used to update the current seismic model.

In Step 520, in accordance with one or more embodiments, a convergence test may be applied. For example, in embodiments where the extremum is a minimum, convergence may be considered to occur when value of the composite penalty function is smaller than a predetermined value. In other embodiments, convergence may occur when the value of the composite penalty function decreases by less than a predetermined value from the previous evaluation of the composite penalty function. In still other embodiments, convergence occur when a predetermined number of iterations are completed, irrespective of the final value of the composite penalty function.

If convergence has occurred the process may terminate. However, is convergence has not occurred, the process may iterate recursively. For example, the refined seismic model may become a new current seismic model in Step (504) and the seismic wavelet may be updated. Similarly, the refined seismic model may be used to augment the plurality of seismic training models and a corresponding deterministic Jacobian and a corresponding seismic training dataset may be determined from the refined seismic model and the updated seismic wavelet using forward modeling.

Iteration of the first and second iterative loops shown in FIG. 4 may continue until convergence is achieved.

The seismic model may be used, together with other available information, to determine subterranean formations with a greater probability of containing hydrocarbons, such as gas or oil, the other neighboring subsurface formations. Further the seismic model may be used to determine locations within these hydrocarbon bearing formations to which wellbores may be drilled, safely and economically, to produce the hydrocarbons.

Prior to the commencement of drilling a wellbore a wellbore plan may be generated. The wellbore plan may include a starting surface location of the wellbore, or a subsurface location within an existing wellbore, from which the wellbore may be drilled. Further, the wellbore plan may include a terminal location that may intersect with the targeted hydrocarbon bearing formation and a planned wellbore path from the starting location to the terminal location.

Typically, the wellbore plan is generated based on best available information from the seismic model, geomechanical models encapsulating subterranean stress conditions, the trajectory of any existing wellbores (that must be avoided), and the existence of other drilling hazards, such as shallow gas pockets, over-pressure zones, and active fault plans. Furthermore, the wellbore plan may take into account other engineering constraints such as the maximum wellbore curvature (“dog-log”) that the drillstring may tolerate and the maximum torque and drag values that the drilling system may tolerate.

A wellbore planning system may be used to generate the wellbore plan. The wellbore planning system may comprise one or more computer processors in communication with computer memory containing the seismic and geomechanical models, information relating to drilling hazards, and the constraints imposed by the limitations of the drillstring and the drilling system. The wellbore planning system may further include dedicated software to determine the planned wellbore path and associated drilling parameters, such as the planned wellbore diameter, the location of planned changes of the wellbore diameter, the planned depths at which casing will be inserted to support the wellbore and to prevent formation fluids entering the wellbore, and the mud weights (densities) and types that may be used during drilling the wellbore.

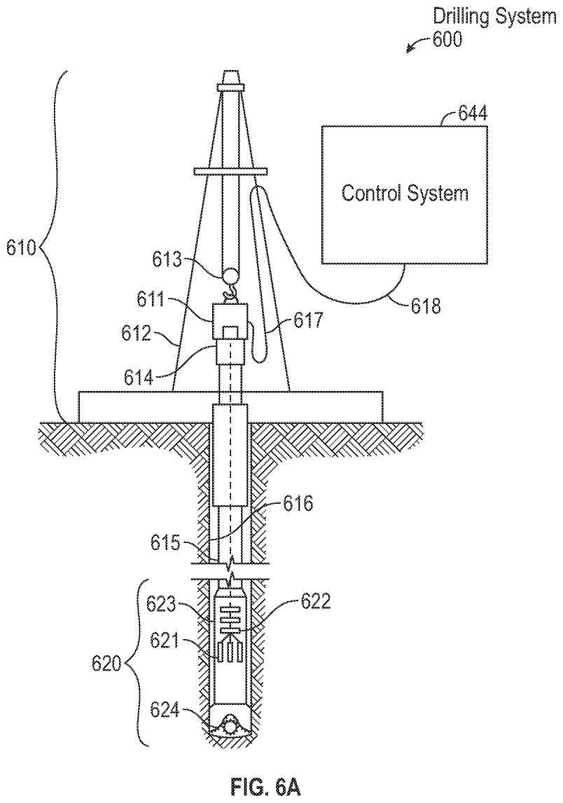

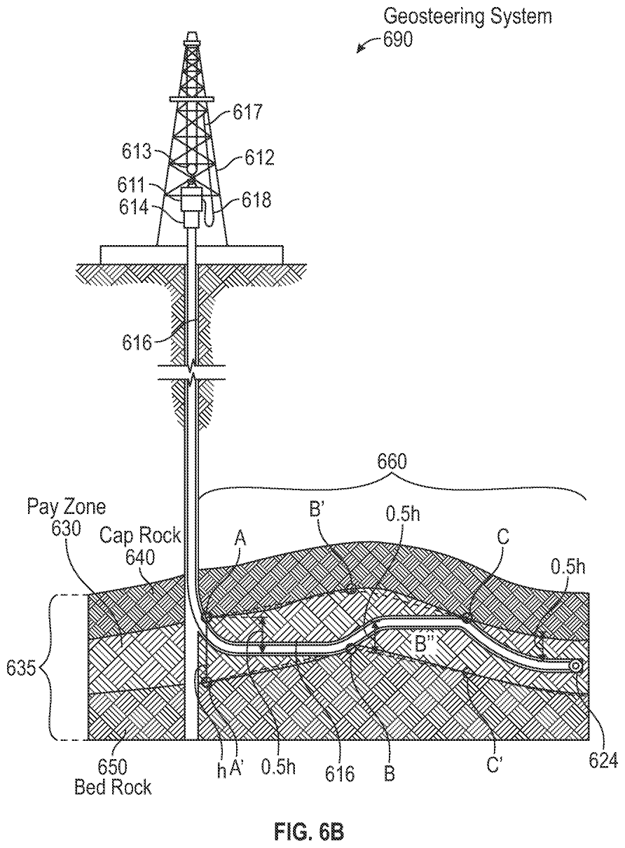

FIGS. 6A and 6B illustrate drilling systems in accordance with one or more embodiments. As shown in FIG. 6A, a drilling system (600) may include a top drive drill rig (610) arranged around the setup of a drill bit logging tool (620). A top drive drill rig (610) may include a top drive (611) that may be suspended in a derrick (612) by a travelling block (613). In the center of the top drive (611), a drive shaft (614) may be coupled to a top pipe of a drill string (615), for example, by threads. The top drive (611) may rotate the drive shaft (614), so that the drill string (615) and a drill bit logging tool (620) cut the rock at the bottom of a wellbore (616). A power cable (617) supplying electric power to the top drive (611) may be protected inside one or more service loops (618) coupled to a control system (644). As such, drilling mud may be pumped into the wellbore (616) through a mud line, the drive shaft (614), and/or the drill string (615).

Moreover, when completing a well, casing may be inserted into the wellbore (616). The sides of the wellbore (616) may require support, and thus the casing may be used for supporting the sides of the wellbore (616). As such, a space between the casing and the untreated sides of the wellbore (616) may be cemented to hold the casing in place. The cement may be forced through a lower end of the casing and into an annulus between the casing and a wall of the wellbore (616). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling mud, may be pumped into the casing above the cementing plug. This displacement fluid may be pressurized fluid that serves to urge the cementing plug downward through the casing to extrude the cement from the casing outlet and back up into the annulus.

As further shown in FIG. 6A, sensors (621) may be included in a sensor assembly (623), which is positioned adjacent to a drill bit (624) and coupled to the drill string (615). Sensors (621) may also be coupled to a processor assembly (623) that includes a processor, memory, and an analog-to-digital converter (622) for processing sensor measurements. For example, the sensors (621) may include acoustic sensors, such as accelerometers, measurement microphones, contact microphones, and hydrophones. Likewise, the sensors (621) may include other types of sensors, such as transmitters and receivers to measure resistivity, gamma ray detectors, etc. The sensors (621) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (600) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The control system (644) may be coupled to the sensor assembly (623) in order to perform various program functions for up-down steering and left-right steering of the drill bit (624) through the wellbore (616). More specifically, the control system (644) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock.

Turning to geosteering, geosteering may be used to position the drill bit (624) or drill string (615) relative to a boundary between different subsurface layers (e.g., overlying, underlying, and lateral layers of a pay zone) during drilling operations. In particular, measuring rock properties during drilling may provide the drilling system (600) with the ability to steer the drill bit (624) in the direction of desired hydrocarbon concentrations. As such, a geosteering system may use various sensors located inside or adjacent to the drilling string (615) to determine different rock formations within a wellbore's path. In some geosteering systems, drilling tools may use resistivity or acoustic measurements to guide the drill bit (624) during horizontal or lateral drilling.

Turning to FIG. 6B, FIG. 6B illustrates some embodiments for steering a drill bit through a lateral pay zone using a geosteering system (690). As shown in FIG. 6B, the geosteering system (690) may include the drilling system (600) from FIG. 6A. In particular, the geosteering system (690) may include functionality for monitoring various sensor signatures (e.g., an acoustic signature from acoustic sensors) that gradually or suddenly change as a well path traverses a cap rock (630), a pay zone (640), and a bed rock (650). Because of the sudden change in lithology between the cap rock (630) and the pay zone (640), for example, a sensor signature of the pay zone (640) may be different from the sensor signature of the cap rock (630). When the drill bit (624) drills out of the pay zone (640) into the cap rock (630), a detected amplitude spectrum of a particular sensor type may change suddenly between the two distinct sensor signatures. In contrast, when drilling from the pay zone (640) downward into the bed rock (650), the detected amplitude spectrum may gradually change.

During the lateral drilling of the wellbore (616), preliminary upper and lower boundaries of a formation layer's thickness may be derived from a seismic survey and/or an offset well obtained before drilling the wellbore (616). If a vertical section (635) of the well is drilled, the actual upper and lower boundaries of a formation layer (i.e., actual pay zone boundaries (A, A′)) and the pay zone thickness (i.e., A to A′) at the vertical section (635) may be determined. Based on this well data, an operator may steer the drill bit (624) through a lateral section (660) of the wellbore (616) in real time. In particular, a logging tool may monitor a detected sensor signature proximate the drill bit (624), where the detected sensor signature may continuously be compared against prior sensor signatures, e.g., of the cap rock (630), pay zone (640), and bed rock (650), respectively. As such, if the detected sensor signature of drilled rock is the same or similar to the sensor signature of the pay zone (640), the drill bit (624) may still be drilling in the pay zone (640). In this scenario, the drill bit (624) may be operated to continue drilling along its current path and at a predetermined distance (0.5h) from a boundary of a formation layer. If the detected sensor signature is same as or similar to the prior sensor signatures of the cap rock (630) or the bed rock (650), respectively, then the control system (644) may determine that the drill bit (624) is drilling out of the pay zone (640) and into the upper or lower boundary of the pay zone (640). At this point, the vertical position of the drill bit (624) at this lateral position within the wellbore (616) may be determined and the upper and lower boundaries of the pay zone (640) may be updated, (for example, positions B and C in FIG. 6B). In some embodiments, the vertical position at the opposite boundary may be estimated based on the predetermined thickness of the pay zone (640), such as positions B′ and C′.

While FIGS. 6A, and 6B shows various configurations of components, other configurations may be used without departing from the scope of the disclosure. For example, various components in FIGS. 6A, and 6B may be combined to create a single component. As another example, the functionality performed by a single component may be performed by two or more components.

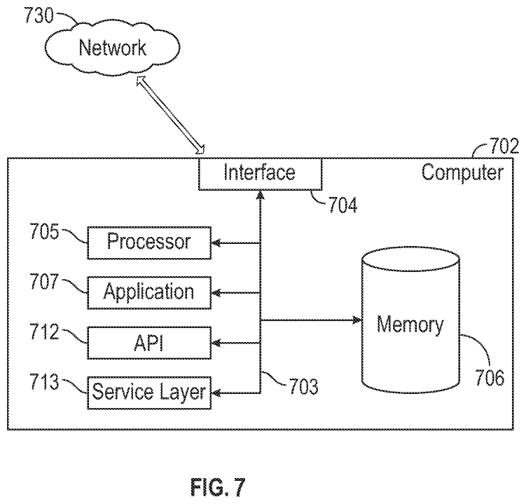

FIG. 7 further depicts a block diagram of a computer system (702) used to provide computational functionalities associated with described algorithms, methods, functions, processes, flows, and procedures as described in this disclosure, according to one or more embodiments. In particular, FIG. 7 may depict a ML engine for performing the method for determining an updated geophysical model (790) for a subterranean region of interest (202).

The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) may be a non-transitory computer readable medium memory (706) can be a database storing data consistent with this disclosure. Although illustrated as a single memory (706) in FIG. 7, two or more memories (706) may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing a computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for determining a refined seismic model of a subterranean region, comprising:
obtaining an observed seismic dataset from the subterranean region;
obtaining a current seismic model of the subterranean region;
training, using a computer processor, a machine learning (ML) network using a plurality of seismic training models and a corresponding seismic training dataset for each seismic training model to produce a trained ML network;
predicting, using the trained ML network, a predicted seismic model from the observed seismic dataset;
determining, using the computer processor, a simulated seismic dataset from the current seismic model and a seismic wavelet using a forward modeling method;
determining, using the computer processor, a data penalty function based on a difference between the observed seismic dataset and the simulated seismic dataset;
determining, using the computer processor, a model penalty function based on a difference between the current seismic model and the predicted seismic model;
determining, using the computer processor, a composite penalty function based, at least in part, on a weighted sum of the data penalty function and the model penalty function; and
determining, using the computer processor, the refined seismic model based, at least in part, on finding an extremum of the composite penalty function.

2. The method of claim 1, further comprising:
determining, using the computer processor, an updated simulated seismic dataset from the refined seismic model and a refined seismic wavelet using the forward modeling method;
determining, using the computer processor, an updated data penalty function based on a difference between the observed seismic dataset and the refined simulated seismic dataset;
determining, using the computer processor, an updated model penalty function based on a difference between the refined seismic model and the predicted seismic model
determining, using the computer processor, an updated composite penalty function based, at least in part, on a weighted sum of the updated data penalty function and the updated model penalty function; and
determining, using the computer processor, an updated seismic model based, at least in part, on finding an extremum of the composite penalty function.

3. The method of claim 1, further comprising:
determining a location of a hydrocarbon reservoir based, at least in part, on the seismic model; and
planning, using a wellbore planning system, a wellbore path to intersect the hydrocarbon reservoir.

4. The method of claim 1, wherein training the ML network further comprises:
forming a composite training penalty function comprising:
a model penalty function measuring the difference between each seismic training model and a predicted seismic training model, predicted by the ML network from the corresponding seismic training dataset, and
a data penalty function based, at least in part, on a ML Jacobian operator; and
training the ML network based, at least in part, on finding an extremum of the composite training penalty function.

5. The method of claim 1, wherein training ML network further comprises:
augmenting the plurality of seismic training models and the corresponding seismic training datasets with the current seismic model and the simulated seismic dataset for the current seismic model; and
retraining the trained ML network based, at least in part, on the augmented plurality of seismic training models and the corresponding seismic training datasets.

6. The method of claim 1, wherein training the ML network further comprises:
forming a composite training penalty function comprising:
a model penalty function measuring the difference between each seismic training model and a predicted seismic training model, predicted by the ML network from the corresponding seismic training dataset, and
a data penalty function based, at least in part, on a deterministic Jacobian operator; and
training the ML network based, at least in part, on finding an extremum of the composite training penalty function.

7. The method of claim 1, wherein the extremum comprises a minimum.

8. The method of claim 1, wherein the forward modelling method comprises a physics-based forward modelling method.

9. A non-transitory computer readable medium, storing instructions executable by a computer processor, the instructions comprising functionality for:
receiving an observed seismic dataset from a subterranean region;
receiving a current seismic model of the subterranean region;
training a machine learning (ML) network using a plurality of seismic training models and a corresponding seismic training dataset for each seismic training model to produce a trained ML network;
using the trained ML network to predict a predicted seismic model from the observed seismic dataset;
determining a simulated seismic dataset from the current seismic model and a seismic wavelet using a forward modeling method;
determining a data penalty function based on a difference between the observed seismic dataset and the simulated seismic dataset;
determining a model penalty function based on a difference between the current seismic model and the predicted seismic model;
determining a composite penalty function based, at least in part, on a weighted sum of the data penalty function and the model penalty function; and
determining a refined seismic model based, at least in part, on finding an extremum of the composite penalty function.

10. The non-transitory computer readable medium of claim 9, the instructions further comprising the functionality for:
determining a location of a hydrocarbon reservoir based, at least in part, on the refined seismic model; and
planning a wellbore path to intersect the hydrocarbon reservoir.

11. The non-transitory computer readable medium of claim 9, wherein training the ML network further comprises:
forming a composite training penalty function comprising:
a model penalty function measuring the difference between each seismic training model and a predicted seismic training model, predicted by the ML network from the corresponding seismic training dataset, and
a data penalty function based, at least in part, on a ML Jacobian operator; and
training the ML network based, at least in part, on finding an extremum of the composite training penalty function.

12. The non-transitory computer readable medium of claim 9, the instructions further comprising the functionality for:
augmenting the plurality of seismic training models and the corresponding seismic training datasets with the current seismic model and the simulated seismic dataset for the current seismic model; and
retraining the trained ML network based, at least in part, on the augmented plurality of seismic training models and the corresponding seismic training datasets.

13. The non-transitory computer readable medium of claim 9, wherein training the ML network further comprises:
forming a composite training penalty function comprising:
a model penalty function measuring the difference between each seismic training model and a predicted seismic training model, predicted by the ML network from the corresponding seismic training dataset, and
a data penalty function based, at least in part, on a deterministic Jacobian operator; and
training the ML network based, at least in part, on finding an extremum of the compo site training penalty function.

14. The non-transitory computer readable medium of claim 9, wherein the extremum comprises a minimum.

15. The non-transitory computer readable medium of claim 9, wherein the forward modelling method comprises a physics-based forward modelling method.

16. A system, comprising:
a seismic acquisition system, configured to acquire an observed seismic dataset;
a computer system, configured to:
receive an observed seismic dataset from a subterranean region,
receive a current seismic model of the subterranean region,
train a machine learning (ML) network using a plurality of seismic training models and a corresponding seismic training dataset for each seismic training model to produce a trained ML network,
use the trained ML network to predict a predicted seismic model from the observed seismic dataset,
determine a simulated seismic dataset from the current seismic model and a seismic wavelet using a forward modeling method,
determine a data penalty function based on a difference between the observed seismic dataset and the simulated seismic dataset,
determine a model penalty function based on a difference between the current seismic model and the predicted seismic model,
determine a composite penalty function based, at least in part, on a weighted sum of the data penalty function and the model penalty function,
determine a refined seismic model based, at least in part, on finding an extremum of the composite penalty function, and
determine a location of a hydrocarbon reservoir based, at least in part, on the refined seismic model; and
a wellbore planning system configured to plan a planned wellbore path to intersect the location of the hydrocarbon reservoir.

17. The system of claim 16, further comprising a drilling system to drill a wellbore guided by the planned wellbore path.

18. The system of claim 16, wherein training the ML network further comprises:
forming a composite training penalty function comprising:
a model penalty function measuring the difference between each seismic training model and a predicted seismic training model, predicted by the ML network from the corresponding seismic training dataset, and
a data penalty function based, at least in part, on a ML Jacobian operator; and
training the ML network based, at least in part, on finding an extremum of the composite training penalty function.

19. The system of claim 16, wherein training the ML network further comprises:
forming a composite training penalty function comprising:
a model penalty function measuring the difference between each seismic training model and a predicted seismic training model, predicted by the ML network from the corresponding seismic training dataset, and
a data penalty function based, at least in part, on a deterministic Jacobian operator; and
training the ML network based, at least in part, on finding an extremum of the composite training penalty function.

20. The system of claim 16, wherein the computer system is further configured to:
augment the plurality of seismic training models and the corresponding seismic training datasets with the current seismic model and the simulated seismic dataset for the current seismic model; and
retrain the trained ML network based, at least in part, on the augmented plurality of seismic training models and the corresponding seismic training datasets.
